(19) United States
(12) Patent Application Publication
(10) Pub. No.: US 2026/0177780 A1
(43) Pub. Date: Jun. 25, 2026

(54) LENS DEVICE AND IMAGING APPARATUS

(71) Applicant: FUJIFILM Corporation, Tokyo (JP)

(72) Inventor: Yukihiro KANEKO, Saitama (JP)

(73) Assignee: FUJIFILM Corporation, Tokyo (JP)

(21) Appl. No.: 19/415,783

(22) Filed: Dec. 11, 2025

(30) Foreign Application Priority Data
Dec. 20, 2024 (JP) 2024-225516

(51) Int. Cl. G02B 7/10; G02B 7/02; G02B 13/00; H04N 23/55

(52) U.S. Cl. CPC G02B 7/10; G02B 7/021; G02B 13/0015; H04N 23/55

(57) ABSTRACT

A lens device includes: a first lens frame that holds a first lens; a holding frame that holds the first lens frame; an adjustment mechanism with which a positional relationship between the holding frame and the first lens frame is adjustable; and a second lens frame that holds a second lens, and a first engagement portion of the holding frame and a second engagement portion of the second lens frame are engaged with each other.

### CROSS-REFERENCE TO RELATED APPLICATIONS

The present application claims priority under 35 U.S.C. §119 to Japanese Patent Application No. 2024-225516 filed on December 20, 2024. The above application is hereby expressly incorporated by reference, in its entirety, into the present application.

### BACKGROUND OF THE INVENTION

### 1. Field of the Invention

The present invention relates to a lens device and an imaging apparatus.

### 2. Description of the Related Art

Described in JP1992-217212A (JPH04-217212A) is a lens barrel in which a front group lens barrel constitutes a first lens holding member holding a front lens group, a middle barrel and a rear group lens barrel constitute a second lens holding member, the rear group lens barrel holds a rear lens group, an engagement claw of the front group lens barrel is fitted into an engagement hole of the middle barrel so that the front group lens barrel and the middle barrel are connected to each other, a bayonet groove of the middle barrel and a bayonet claw of the rear group lens barrel are engaged with each other so that the middle barrel and the rear group lens barrel are connected to each other, an engagement claw of the middle barrel is fitted into a front disc plane of a stop unit so that the stop unit and the middle barrel are connected to each other, a key portion for forward movement of the middle barrel is fitted into a groove of a fixation barrel, a cam follower portion of a focus adjustment member is fitted into a cam groove space formed by a cam surface of the front group lens barrel and a cam surface of the middle barrel, and the front group lens barrel, the middle barrel, and the rear group lens barrel are integrally moved in an optical axis direction via the cam follower portion as the focus adjustment member rotationally moves.

Described in JP2006-113393A is a lens barrel that is a single-focus lens and in which a front lens group, a shutter blade, and a rear lens group are disposed in a rotary barrel disposed in a fixation barrel, the diameter of the rear lens group is larger than the diameter of the front lens group, engagement portions that are bayonet-coupled to each other are formed at a rear end side of an inner peripheral surface of a movement barrel and a lens holding frame holding the rear lens group, and a rear lens unit is fixed in the movement barrel.

### SUMMARY OF THE INVENTION

One embodiment according to the present disclosed technology provides a lens device and an imaging apparatus with which it is possible to achieve reduction in device size.

(1) A lens device including:

a first lens frame that holds a first lens;

a holding frame that holds the first lens frame;

an adjustment mechanism with which a positional relationship between the holding frame and the first lens frame is adjustable; and

a second lens frame that holds a second lens,

in which a first engagement portion of the holding frame and a second engagement portion of the second lens frame are engaged with each other.

(2) The lens device according to (1), in which the adjustment mechanism includes

a first adjustment mechanism with which inclination of the first lens frame with respect to the holding frame is adjustable, and

a second adjustment mechanism with which a position of the first lens frame with respect to the holding frame is adjustable.

(3) The lens device according to (2),

in which the holding frame includes a plurality of the first engagement portions, and

the second lens frame includes a plurality of the second engagement portions.

(4) The lens device according to (3),

in which the first adjustment mechanism, the second adjustment mechanism, and the first engagement portions are disposed along a circumferential direction around an optical axis.

(5) The lens device according to (4),

in which the first adjustment mechanism, the second adjustment mechanism, and the first engagement portions are disposed at different positions in the circumferential direction around the optical axis.

(6) The lens device according to any one of (1) to (5),

in which the first engagement portion and the second engagement portion are engaged with each other in a bayonet manner or a snap-fit manner.

(7) The lens device according to (6),

in which the first engagement portion of the holding frame and the second engagement portion of the second lens frame are engaged with each other in the bayonet manner, and

at least one of the first engagement portion of the holding frame or the second engagement portion of the second lens frame includes an insertion port into which a stopper member that maintains the bayonet engagement is insertable in a direction intersecting an optical axis.

(8) The lens device according to any one of (1) to (7),

in which the second lens frame includes a light amount adjustment member, and

the second lens includes a lens of which an outer diameter is larger than an outer diameter of the light amount adjustment member as seen in an optical axis direction.

(9) The lens device according to (1), further including

a moving mechanism that moves the first lens and the second lens with respect to a housing.

(10) The lens device according to (9),

in which the moving mechanism is a mechanism that moves the first lens and the second lens while maintaining relative positions of the first lens and the second lens.

(11) The lens device according to (10), in which the moving mechanism includes

a fixed cylinder that is fixed to the housing and that includes a groove portion,

a cam cylinder that includes a cam groove, and

a cam follower that is provided at the second lens frame, and the cam follower is engaged with the cam groove via the groove portion.

(12) An imaging apparatus including the lens device according to any one of (1) to (11).

According to the present invention, it is possible to provide a lens device and an imaging apparatus with which it is possible to achieve reduction in device size.

### BRIEF DESCRIPTION OF THE DRAWINGS

FIG. 1 is a perspective view showing an example of a lens device 100 of the present embodiment.

FIG. 2 is a vertical cross-sectional view showing a configuration of the lens device 100.

FIG. 3 is a perspective view showing a configuration of a first lens frame 10.

FIG. 4 is a perspective view showing a configuration of a holding frame 30.

FIG. 5 is a perspective view showing a configuration of a second lens frame 20.

FIG. 6 is a perspective view showing an example of a state where the first lens frame 10, the holding frame 30, the second lens frame 20, and an adjustment mechanism 40 are mounted to each other.

FIG. 7 is a front view showing an example of a state where the first lens frame 10, the holding frame 30, and the adjustment mechanism 40 are mounted to each other.

FIG. 8 is a front view showing an example of a state where the holding frame 30, the second lens frame 20, and the adjustment mechanism 40 are mounted to each other.

FIG. 9 is a perspective view showing an example of a state where the holding frame 30 and the second lens frame 20 are mounted to each other.

FIG. 10 is a side view showing an example of a state where the holding frame 30 and the second lens frame 20 are mounted to each other.

FIG. 11 is a perspective view showing a cam mechanism 60 of the lens device 100.

FIG. 12 is a perspective view showing a fixed cylinder 61 of the cam mechanism 60.

FIG. 13 is a perspective view showing a cam cylinder 62 of the cam mechanism 60.

FIG. 14 is a perspective view showing the way in which an FPC 51 connected to a stop unit 50 is led out.

### DESCRIPTION OF THE PREFERRED EMBODIMENTS

Hereinafter, an example of an embodiment of the present invention will be described with reference to the drawings. In the present embodiment, the terms "upward direction", "downward direction", "leftward direction", "rightward direction", "forward direction", and "backward direction" are used. However, such directions are relative directions set for convenience of description regarding a lens device shown in the drawings.

### Lens Device of Embodiment

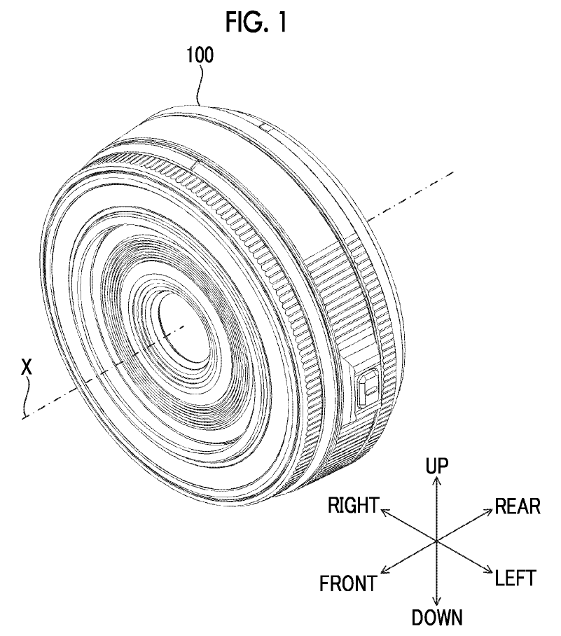

FIG. 1 is a perspective view showing an example of a lens device 100 of the present embodiment. The lens device 100 is applied to, for example, a digital camera or a single-lens reflex camera with which it is possible to capture a motion picture. The camera is an example of an "imaging apparatus" according to the embodiment of the present invention. The lens device 100 is attachable to and detachable from a camera body (not shown). The lens device 100 is configured to have an approximately cylindrical shape as a whole.

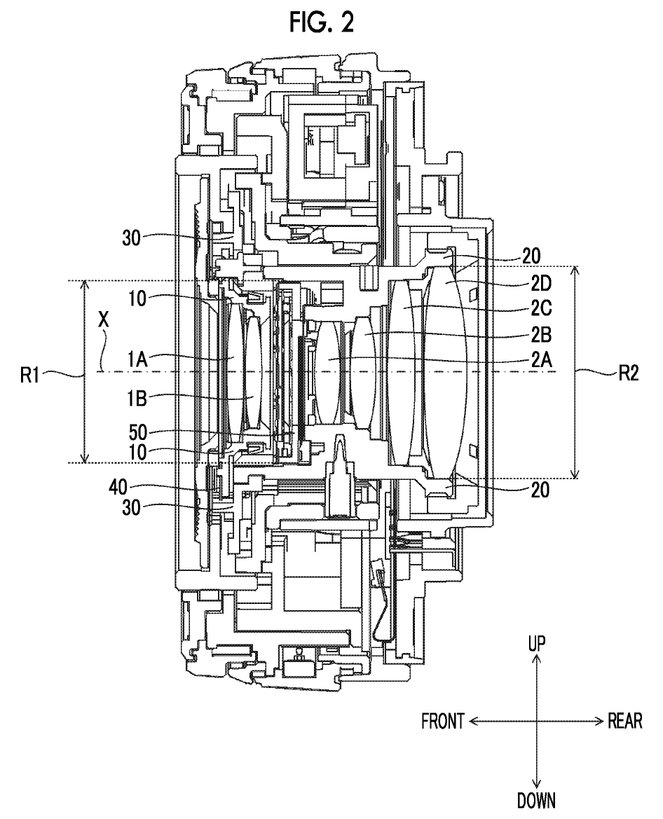

FIG. 2 is a vertical cross-sectional view showing a configuration of the lens device 100. As shown in FIG. 2, the lens device 100 includes front group lenses (for example, first lenses 1A and 1B) disposed in a front portion of the lens device 100 and rear group lenses (for example, second lenses 2A, 2B, 2C, and 2D) disposed in a rear portion of the lens device 100. The "first lenses 1A and 1B" are one or more lenses positioned ahead of (on a subject side) the second lenses 2A, 2B, 2C, and 2D. The "second lenses 2A to 2D" are one or more lenses positioned behind (on an imaging element side) the first lenses 1A and 1B.

In addition, the lens device 100 includes a first lens frame 10 that holds the first lenses 1A and 1B, a holding frame 30 that holds the first lens frame 10, an adjustment mechanism 40 with which a positional relationship between the holding frame 30 and the first lens frame 10 is adjustable, and a second lens frame 20 that holds the second lenses 2A to 2D. The "positional relationship" between the holding frame 30 and the first lens frame 10 is at least any of a position (a shift position) on a plane perpendicular to an optical axis X or inclination (tilt). The "optical axis X" is the optical axis of an optical system composed of the first lenses 1A and 1B and the second lenses 2A to 2D.

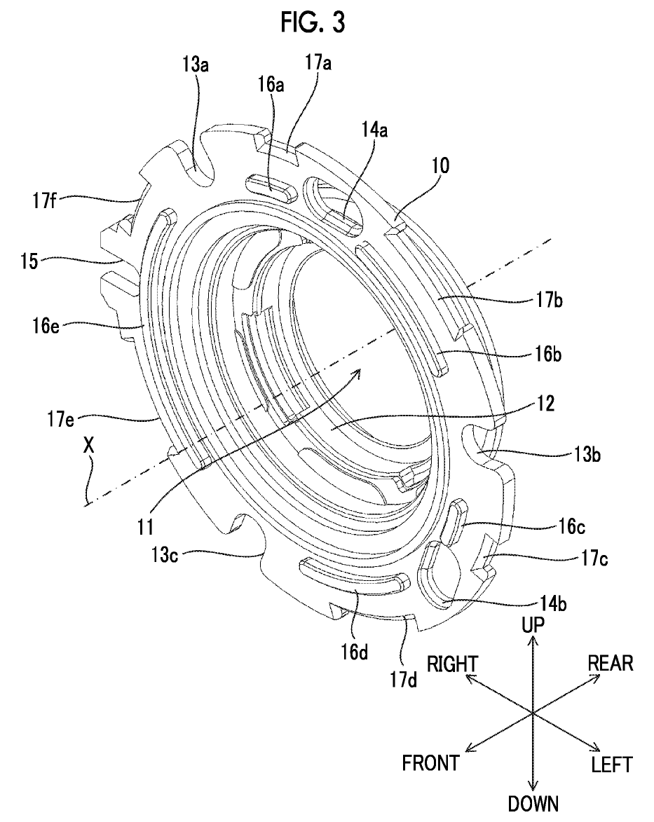

The adjustment mechanism 40 includes a tilt adjustment mechanism with which the inclination of the first lens frame 10 with respect to the holding frame 30 is adjustable and a shift adjustment mechanism with which the relative position of the first lens frame 10 with respect to the holding frame 30 is adjustable. The "tilt adjustment mechanism" includes, for example, a screw hole of the holding frame 30, a through-hole of the first lens frame 10, and a tilt adjustment screw and the inclination of the first lens frame 10 with respect to the holding frame 30 is adjusted by tightening or loosening the tilt adjustment screw. The "shift adjustment mechanism" includes, for example, a screw hole of the holding frame 30, a through-hole of the first lens frame 10, and a shift adjustment screw, and the position of the first lens frame 10 with respect to the holding frame 30 is adjusted by tightening or loosening the shift adjustment screw. The shift adjustment screw is composed of, for example, an eccentric screw. The tilt adjustment mechanism is an example of a "first adjustment mechanism" according to the embodiment of the present invention. The shift adjustment mechanism is an example of a "second adjustment mechanism" according to the embodiment of the present invention. The "tilt adjustment mechanism" and the "shift adjustment mechanism" will be described later with reference to FIGS. 3, 4, and 6.

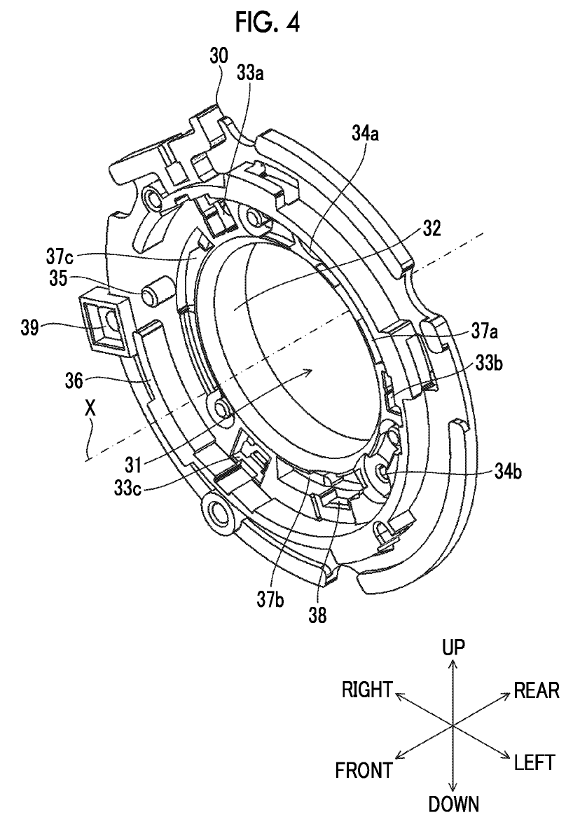

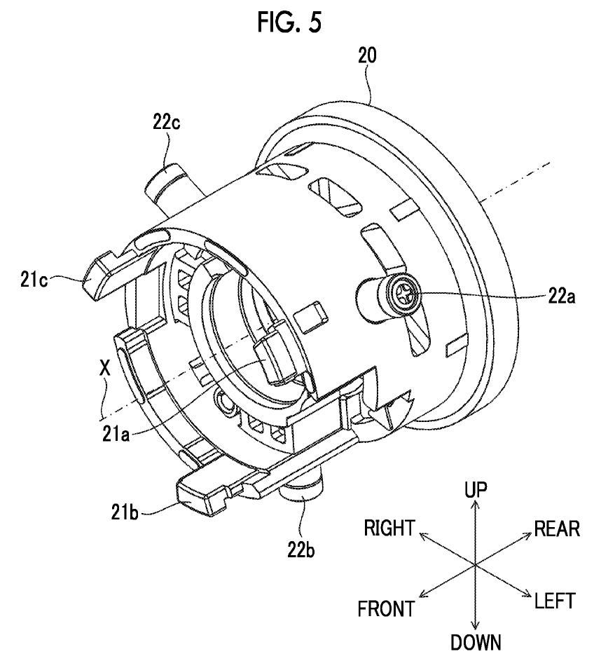

The holding frame 30 and the second lens frame 20 are engaged with each other in a bayonet manner or a snap-fit manner, for example. The holding frame 30 has a first engagement portion to be engaged with the second lens frame 20. The second lens frame 20 has a second engagement portion to be engaged with the holding frame 30. The holding frame 30 and the second lens frame 20 are connected to each other through non-screw fixation, with the first engagement portion of the holding frame 30 and the second engagement portion of the second lens frame 20 bayonet-engaged with each other. The first engagement portion and the second engagement portion will be described later with reference to FIGS. 4 and 5.

The second lens frame 20 includes a stop unit 50. The stop unit 50 is provided at a front end portion of the second lens frame 20. The stop unit 50 is an example of a "light amount adjustment member" according to the embodiment of the present invention. The stop unit 50 adjusts an opening amount of a stop under control of a stop drive unit (not shown). As an example of the "light amount adjustment member", for example, an "electronic neutral density (ND) filter" may be used instead of a "stop unit".

The second lenses 2A to 2D include a lens that is larger than the outer diameter R1 of the stop unit 50 as seen in a direction along the optical axis X. The expression “large” means that a circle that extends around the optical axis X and that circumscribes the second lenses 2A to 2D is larger than a circle that extends around the optical axis X and that circumscribes the stop unit 50. In the present example, an outer diameter R2 of the second lens 2D, which is one of the second lenses 2A to 2D, is larger than the outer diameter R1 of the stop unit 50. Note that the expression “large” corresponds to cases where the outer diameter of the largest one of the second lenses is larger than the outer diameter R1 of the stop unit 50.

FIG. 3 is a perspective view showing a configuration of the first lens frame 10. As shown in FIG. 3, the first lens frame 10 is formed in an approximately disk-like shape, and a circular opening portion 11 that is open at the optical axis X and the vicinity of the optical axis X is formed in a central portion of the first lens frame 10. In addition, a protruding portion 12 that protrudes in an annular shape toward a rear side is formed on a rear surface side of the first lens frame 10.

In addition, through-holes 13a, 13b, and 13c constituting the tilt adjustment mechanism and through-holes 14a and 14b constituting the shift adjustment mechanism are formed in the first lens frame 10. In addition, a boss hole 15 that is engaged with a positioning boss 35 (which will be described later with reference to FIG. 4) provided at the holding frame 30 is formed in the first lens frame 10.

In addition, arc-shaped ribs 16a, 16b, 16c, 16d, and 16e protruding to a front side are formed on a front surface side of the first lens frame 10. In addition, notches 17a, 17b, 17c, 17d, 17e, and 17f that are recessed radially inward are formed at the peripheral portion of the first lens frame 10. The notches 17a to 17f are notches into which, for example, an adhesive is poured so that the first lens frame 10 is fixed to the holding frame 30 after the inclination and position of the first lens frame 10 with respect to the holding frame 30 are adjusted.

Regarding the first lens frame 10, the through-holes 13a to 13c constituting the tilt adjustment mechanism and the through-holes 14a and 14b constituting the shift adjustment mechanism are disposed along a circumferential direction around the optical axis X. In addition, regarding the first lens frame 10, the through-holes 13a to 13c constituting the tilt adjustment mechanism and the through-holes 14a and 14b constituting the shift adjustment mechanism are disposed at different positions in the circumferential direction around the optical axis X.

The expression "different positions in the circumferential direction around the optical axis X" means, for example, that the through-hole 14a of the shift adjustment mechanism is disposed between the through-hole 13a and the through-hole 13b of the tilt adjustment mechanism and the through-hole 14b of the shift adjustment mechanism is disposed between the through-hole 13b and the through-hole 13c of the tilt adjustment mechanism, or that the through-hole 13b of the tilt adjustment mechanism is disposed between the through-hole 14a and the through-hole 14b of the shift adjustment mechanism.

In addition, regarding the first lens frame 10, the notches 17a to 17f, the through-holes 13a to 13c of the tilt adjustment mechanism, and the through-holes 14a and 14b of the shift adjustment mechanism are disposed at different positions in the circumferential direction around the optical axis X. Note that the peripheral portion of the first lens frame 10 may be provided with, for example, protrusions instead of the notches 17a to 17f.

In addition, regarding the first lens frame 10, the ribs 16a to 16e, the through-holes 13a to 13c of the tilt adjustment mechanism, and the through-holes 14a and 14b of the shift adjustment mechanism are disposed at different positions in the circumferential direction around the optical axis X. In addition, the surface roughness of portions of a front surface of the first lens frame 10 that correspond to the ribs 16a to 16e is different from the surface roughness of a portion of a front surface of the first lens frame 10 that does not correspond to the ribs 16a to 16e.

It is possible to recognize the positions of the ribs 16a to 16e based on surface roughness through, for example, image recognition and to use the ribs 16a to 16e as markers for recognition of the orientation of the first lens frame 10 or the position of the entire first lens frame 10 based on the recognized positions. Accordingly, the ribs 16a to 16e can be used for optical adjustment and detection of an assembly initial position in automatic assembly of the lens device 100. Note that the front surface side of the first lens frame 10 may be provided with, for example, grooves instead of the ribs 16a to 16e.

In addition, regarding the first lens frame 10, the ribs 16a to 16e and the notches 17a to 17f are disposed at different positions in a radial direction while being disposed at the same positions in the direction around the optical axis X. The ribs 16a to 16e are provided inward of the notches 17a to 17f.

FIG. 4 is a perspective view showing a configuration of the holding frame 30. As shown in FIG. 4, the holding frame 30 is formed in an approximately disk-like shape, and a circular opening portion 31 that is open at the optical axis X and the vicinity of the optical axis X is formed in a central portion of the holding frame 30. In addition, a protruding portion 32 that protrudes in an annular shape toward a rear side is formed on a rear surface side of the holding frame 30.

In addition, screw holes 33a, 33b, and 33c constituting the tilt adjustment mechanism and screw holes 34a and 34b constituting the shift adjustment mechanism are formed in the holding frame 30. In addition, the positioning boss 35 that is engaged with the boss hole 15 provided at the first lens frame 10 is formed at the holding frame 30. The positioning boss 35 is a boss that serves as a reference in a case where the position of the first lens frame 10 is to be determined with respect to the holding frame 30.

In addition, a circular or arc-shaped rib 36 that protrudes to the front side is formed on a front surface side of the holding frame 30. In the example shown in FIG. 4, the arc-shaped rib 36 of which a portion facing the positioning boss 35 is cutout is formed. The rib 36 is formed outward of the positioning boss 35 in the radial direction of the holding frame 30. In addition, the rib 36 is formed outside the screw holes 33a to 33c and the screw holes 34a and 34b in a radial direction of the holding frame 30.

In addition, groove engagement portions 37a, 37b, and 37c to be, for example, bayonet-engaged with the second lens frame 20 are formed at the holding frame 30. A plurality of (three in the present example) groove engagement portions are formed. The groove engagement portions 37a to 37c are examples of a "first engagement portion" according to the embodiment of the present invention.

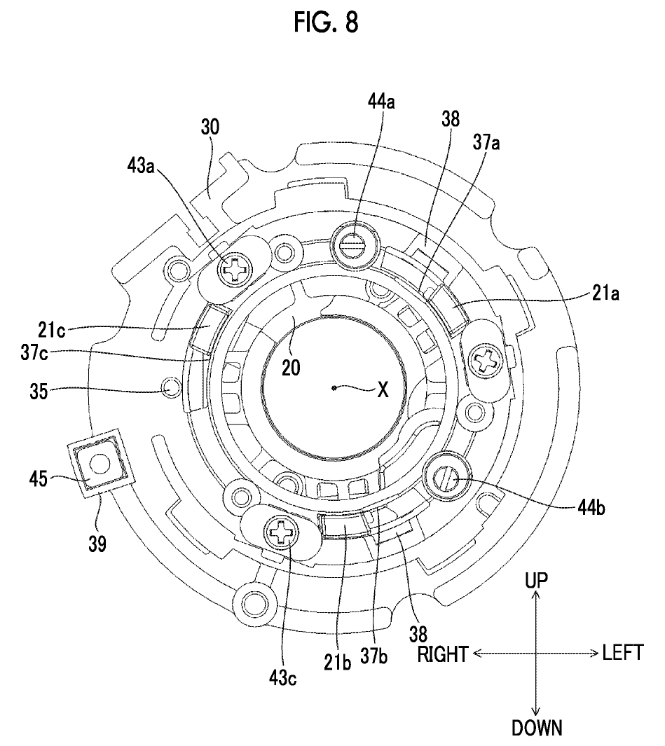

In addition, an insertion port 38 into which, for example, a stopper member provided to maintain bayonet engagement between the holding frame 30 and the second lens frame 20 is insertable is formed at the holding frame 30. The insertion port 38 will be described later with reference to FIGS. 8, 9, and 10.

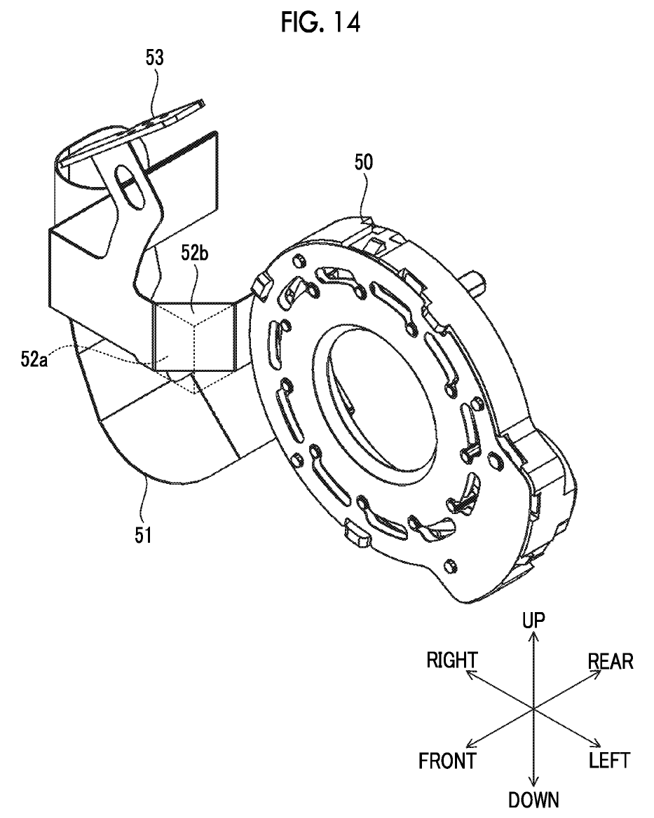

In addition, an attachment portion 39 to which a metal sheet 53 (which will be described later with reference to FIG. 14) for positional stabilization of a lead wire of a flexible printed circuit (FPC) connected to the stop unit 50 is fixed is formed at the holding frame 30.

Regarding the holding frame 30, the screw holes 33a to 33c constituting the tilt adjustment mechanism, the screw holes 34a and 34b constituting the shift adjustment mechanism, and the groove engagement portions 37a to 37c are disposed along the circumferential direction around the optical axis X. In addition, regarding the holding frame 30, the screw holes 33a to 33c constituting the tilt adjustment mechanism, the screw holes 34a and 34b constituting the shift adjustment mechanism, and the groove engagement portions 37a to 37c are disposed at different positions in the circumferential direction around the optical axis X. In addition, the screw holes 33a to 33c are formed at intervals to correspond to the positions of the through-holes 13a to 13c of the first lens frame 10, respectively. The screw holes 34a and 34b are formed at intervals to correspond to the positions of the through-holes 14a and 14b of the first lens frame 10, respectively.

In a case where the first lens frame 10 is to be held at the holding frame 30, the boss hole 15 of the first lens frame 10 is engaged with the positioning boss 35 of the holding frame 30 from the front surface side of the holding frame 30 and the protruding portion 12 of the first lens frame 10 is fitted into the opening portion 31 and the protruding portion 32 of the holding frame 30 after the screw holes 33a to 33c and the screw holes 34a and 34b of the holding frame 30 are positionally aligned with the through-holes 13a to 13c and the through-holes 14a and 14b of the first lens frame 10, respectively.

FIG. 5 is a perspective view showing a configuration of the second lens frame 20. As shown in FIG. 5, the second lens frame 20 is formed in an approximately cylindrical shape. As described with reference to FIG. 2, the second lenses 2A to 2D are held in the second lens frame 20. In addition, the second lens frame 20 is provided with the stop unit 50.

In addition, claw engagement portions 21a, 21b, and 21c to be, for example, bayonet-engaged with the holding frame 30 are formed at the second lens frame 20. A plurality of (three in the present example) claw engagement portions are formed. The claw engagement portions 21a to 21c are provided to extend in a forward direction from a front end of the second lens frame 20 and claw portions of the claw engagement portions 21a to 21c protrude radially outward. The claw engagement portions 21a to 21c are examples of a "second engagement portion" according to the embodiment of the present invention. The claw engagement portions 21a to 21c of the second lens frame 20 are bayonet-engaged with the groove engagement portions 37a to 37c of the holding frame 30, respectively. The claw engagement portions 21a to 21c are formed at intervals to correspond to the positions of the groove engagement portions 37a to 37c, respectively.

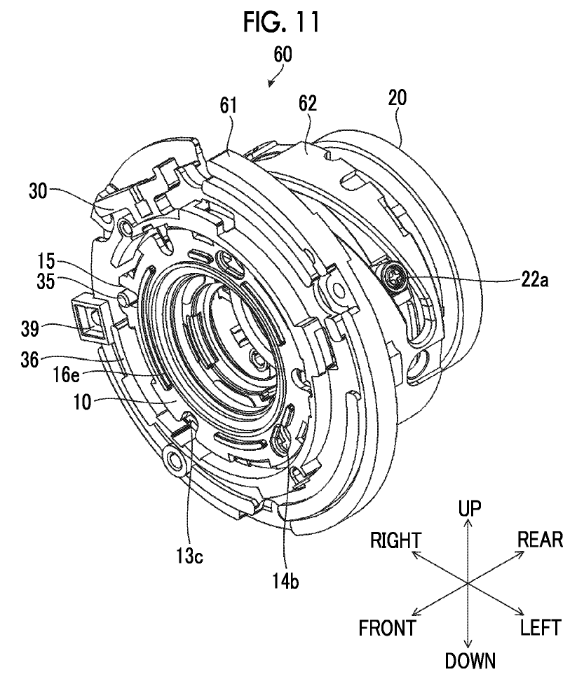

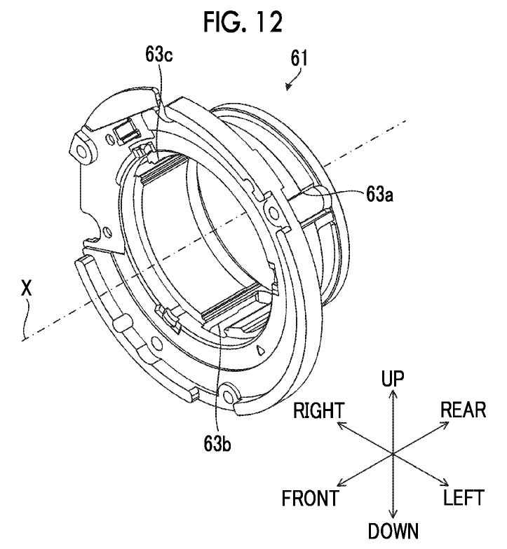

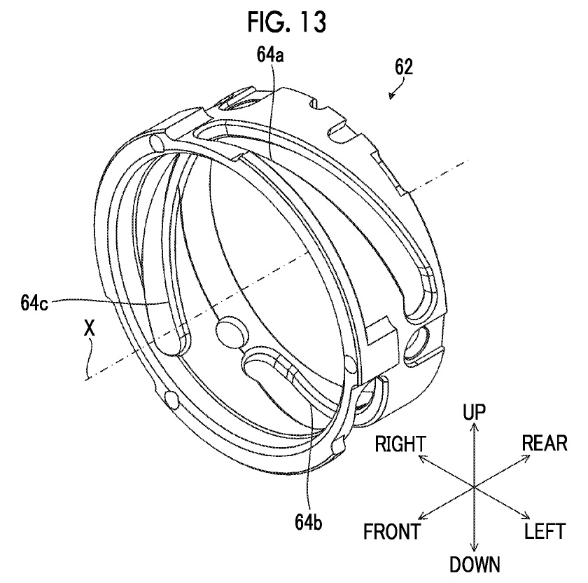

In addition, cam followers 22a, 22b, and 22c extending radially outward are attached to an outer peripheral portion of the second lens frame 20. The cam followers 22a, 22b, and 22c are attached at equal intervals (intervals of 120 degrees). The cam followers 22a, 22b, and 22c are attached, for example, at positions corresponding to the positions of the claw engagement portions 21a to 21c. The cam followers 22a, 22b, and 22c are engaged with a fixed cylinder 61 (which will be described later with reference to FIGS. 11 and 12) and a cam cylinder 62 (which will be described later with reference to FIGS. 11 and 13) constituting a cam mechanism 60 (which will be described later with reference to FIG. 11).

In a case where the second lens frame 20 and the holding frame 30 are to be engaged with each other, the holding frame 30 is mounted from a front side of the fixed cylinder 61, the second lens frame 20 is mounted from a rear side of the fixed cylinder 61, and the claw engagement portions 21a to 21c of the second lens frame 20 are engaged with the groove engagement portions 37a to 37c of the holding frame 30, respectively.

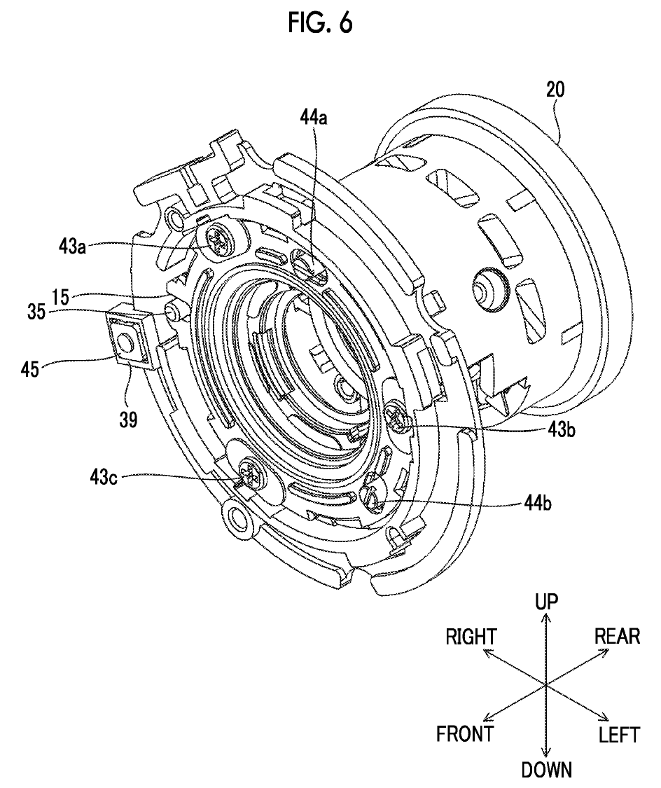

FIG. 6 is a perspective view showing an example of a state where the first lens frame 10, the holding frame 30, the second lens frame 20, and the adjustment mechanism 40 are mounted to each other. As shown in FIG. 6, the boss hole 15 of the first lens frame 10 is engaged with the positioning boss 35 of the holding frame 30, and tilt adjustment screws 43a, 43b, and 43c constituting the tilt adjustment mechanism and shift adjustment screws 44a and 44b constituting the shift adjustment mechanism are attached.

The tilt adjustment screw 43a is screwed into the screw hole 33a of the holding frame 30 via the through-hole 13a of the first lens frame 10. The tilt adjustment screw 43b is screwed into the screw hole 33b of the holding frame 30 via the through-hole 13b of the first lens frame 10. The tilt adjustment screw 43c is screwed into the screw hole 33c of the holding frame 30 via the through-hole 13c of the first lens frame 10. In addition, the shift adjustment screw 44a is screwed into the screw hole 34a of the holding frame 30 via the through-hole 14a of the first lens frame 10. The shift adjustment screw 44b is screwed into the screw hole 34b of the holding frame 30 via the through-hole 14b of the first lens frame 10.

The three tilt adjustment screws 43a, 43b, and 43c are attached at equal intervals (intervals of 120 degrees) in the circumferential direction around the optical axis X. The shift adjustment screw 44a is attached between the tilt adjustment screw 43a and the tilt adjustment screw 43b in the circumferential direction around the optical axis X. The shift adjustment screw 44b is attached between the tilt adjustment screw 43b and the tilt adjustment screw 43c in the circumferential direction around the optical axis X. The positioning boss 35 is provided between the tilt adjustment screw 43c and the tilt adjustment screw 43a.

The tilt adjustment mechanism includes a first tilt adjustment mechanism composed of the tilt adjustment screw 43a, the through-hole 13a of the first lens frame 10, and the screw hole 33a of the holding frame 30, a second tilt adjustment mechanism composed of the tilt adjustment screw 43b, the through-hole 13b of the first lens frame 10, and the screw hole 33b of the holding frame 30, and a third tilt adjustment mechanism composed of the tilt adjustment screw 43c, the through-hole 13c of the first lens frame 10, and the screw hole 33c of the holding frame 30.

The shift adjustment mechanism includes a first shift adjustment mechanism composed of the shift adjustment screw 44a, the through-hole 14a of the first lens frame 10, and the screw hole 34a of the holding frame 30, and a second shift adjustment mechanism composed of the shift adjustment screw 44b, the through-hole 14b of the first lens frame 10, and the screw hole 34b of the holding frame 30.

The first lens frame 10 is mounted inward of the arc-shaped ribs 36 formed on the holding frame 30. It is possible to adjust the inclination of the first lens frame 10 with respect to the holding frame 30, that is, the inclination of the first lenses 1A and 1B held by the first lens frame 10 by tightening and loosening the tilt adjustment screws 43a, 43b, and 43c. In addition, it is possible to adjust the position of the first lens frame 10 with respect to the holding frame 30, that is, the positions of the first lenses 1A and 1B held by the first lens frame 10 by tightening and loosening the shift adjustment screws 44a and 44b.

In addition, a nut 45 for fixation of a metal sheet 53 (which will be described later with reference to FIG. 14) that supports the FPC of the stop unit 50 is attached in the attachment portion 39 of the holding frame 30. A screw inserted from a rear side of the attachment portion 39 is screwed into the nut 45 so that the metal sheet 53 is fixed to the rear side of the attachment portion 39.

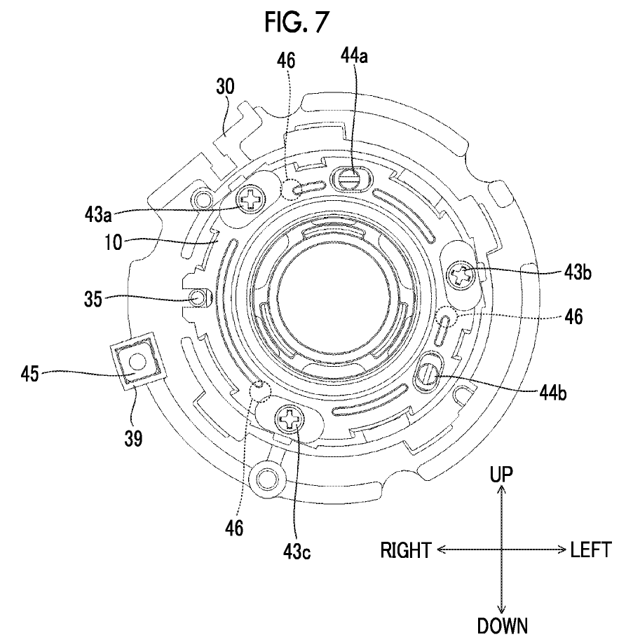

FIG. 7 is a front view showing an example of a state where the first lens frame 10, the holding frame 30, and the adjustment mechanism 40 are mounted to each other. As shown in FIG. 7, springs 46 are provided between the holding frame 30 and the first lens frame 10 mounted to the holding frame 30. The springs 46 are springs that bias the holding frame 30 and the first lens frame 10 to be separated from each other. A plurality of (three in the present example) springs 46 are provided, and are disposed, for example, at positions close to the tilt adjustment screws 43a, 43b, and 43c, respectively. In a case where the inclination of the first lens frame 10 is to be adjusted, the tilt adjustment screws 43a, 43b, and 43c are adjusted on an assumption that the springs 46 bias the first lens frame 10.

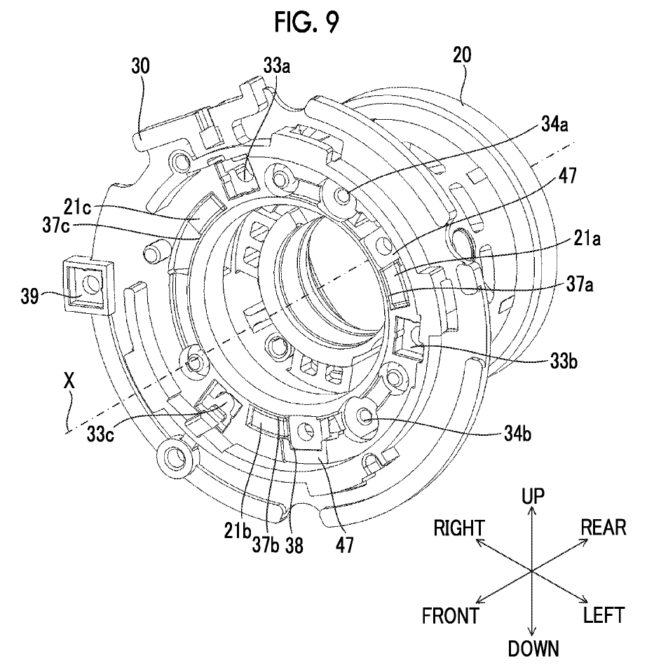

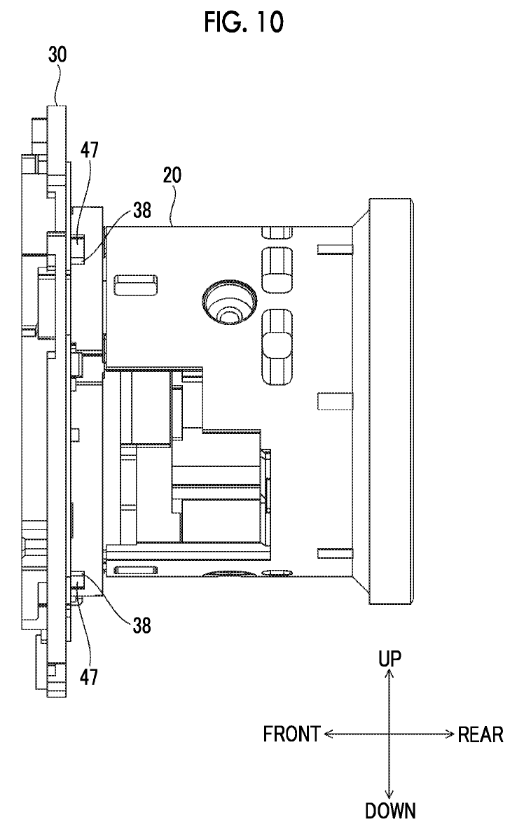

FIG. 8 is a front view showing an example of a state where the holding frame 30, the second lens frame 20, and the adjustment mechanism 40 are mounted to each other. FIG. 9 is a perspective view showing an example of a state where the holding frame 30 and the second lens frame 20 are mounted to each other. FIG. 10 is a side view showing an example of a state where the holding frame 30 and the second lens frame 20 are mounted to each other. Note that in FIG. 8, the tilt adjustment screws 43a to 43c and the shift adjustment screws 44a and 44b of the adjustment mechanism 40 are attached to a combination of the holding frame 30 and the second lens frame 20.

As shown in FIGS. 8 to 10, the holding frame 30 and the second lens frame 20 are connected to each other with the claw engagement portion 21a of the second lens frame 20 engaged with the groove engagement portion 37a of the holding frame 30, the claw engagement portion 21b of the second lens frame 20 engaged with the groove engagement portion 37b of the holding frame 30, and the claw engagement portion 21c of the second lens frame 20 engaged with the groove engagement portion 37c of the holding frame 30.

The claw engagement portions 21a to 21c of the second lens frame 20 that are engaged with the groove engagement portions 37a to 37c of the holding frame 30, the tilt adjustment screws 43a to 43c that constitute the tilt adjustment mechanism, and the shift adjustment screws 44a and 44b that constitute the shift adjustment mechanism are disposed along the circumferential direction around the optical axis X. In addition, the claw engagement portions 21a to 21c, the tilt adjustment screws 43a to 43c, and the shift adjustment screws 44a and 44b are disposed at different positions in the circumferential direction around the optical axis X.

The holding frame 30 and the second lens frame 20 are engaged with each other in a bayonet manner, and at least one of the groove engagement portions 37a to 37c of the holding frame 30 or the claw engagement portions 21a to 21c of the second lens frame 20 includes the insertion port 38 into which a stopper member 47 that maintains bayonet engagement is insertable. The stopper member 47 is insertable into the insertion port 38 in a direction intersecting the optical axis X. The expression "at least one of the groove engagement portions 37a to 37c of the holding frame 30 or the claw engagement portions 21a to 21c of the second lens frame 20" means the groove engagement portions 37a to 37c on a female side (in the present example, the holding frame 30) of a bayonet structure.

As described above, the lens device 100 of the present embodiment includes the first lens frame 10 that holds the first lenses 1A and 1B, the holding frame 30 that holds the first lens frame 10, the tilt adjustment mechanism with which the inclination of the first lens frame 10 with respect to the holding frame 30 is adjustable, the shift adjustment mechanism with which the position of the first lens frame 10 with respect to the holding frame 30 is adjustable, and the second lens frame 20 that holds the second lenses 2A to 2D, and the groove engagement portions 37a to 37c of the holding frame 30 and the claw engagement portions 21a to 21c of the second lens frame 20 are engaged with each other in a bayonet manner. Meanwhile, in recent years, due to an increase in resolution of wide-angle lenses, an increase in size of a final lens (a rear lens) or a lens adjacent to the final lens is inevitable. In addition, a complicated adjustment mechanism is needed for realization of high resolution. On the other hand, according to the lens device 100, since the holding frame 30 and the second lens frame 20 are engaged with each other in a bayonet manner, a screw-fastening structure between the holding frame 30 and the second lens frame 20 can be omitted. Therefore, it is possible to reduce the size of an engagement space required for engagement between the holding frame 30 and the second lens frame 20. Accordingly, it is possible to realize size reduction of the lens device 100 even in a case where an adjustment mechanism between the first lens frame 10 and the holding frame 30 is required or a case where an increase in lens size is required.

In addition, according to the lens device 100, the second lens frame 20 includes the stop unit 50, and the second lenses 2A to 2D include a lens that is larger than the outer diameter R1 of the stop unit 50 as seen in the direction along the optical axis X. As described above, in a case where the second lenses 2A to 2D include a lens of which the diameter is larger than the outer diameter of the stop unit 50, it is possible to realize size reduction of the lens device 100 since the holding frame 30 and the second lens frame 20 are engaged with each other in a bayonet manner.

In addition, according to the lens device 100, the tilt adjustment screws 43a, 43b, and 43c of the tilt adjustment mechanism, the shift adjustment screws 44a and 44b of the shift adjustment mechanism, and the groove engagement portions 37a to 37c of the holding frame 30 are disposed along the circumferential direction around the optical axis X. Therefore, it is possible to suppress radial expansion of each member and to reduce the size of the lens device 100.

In addition, according to the lens device 100, the tilt adjustment screws 43a, 43b, and 43c of the tilt adjustment mechanism, the shift adjustment screws 44a and 44b of the shift adjustment mechanism, and the groove engagement portions 37a to 37c of the holding frame 30 are disposed at different positions in the circumferential direction around the optical axis X. Accordingly, it is possible to achieve both the tilt adjustment and shift adjustment of the first lens frame 10 with respect to the holding frame 30 and bayonet engagement between the holding frame 30 and the second lens frame 20.

In addition, according to the lens device 100, the insertion port 38 is formed in at least one of the groove engagement portions 37a to 37c of the holding frame 30 or the claw engagement portions 21a to 21c of the second lens frame 20 in the direction intersecting the optical axis X, and the stopper member 47 is inserted into the insertion port 38 so that bayonet engagement between the holding frame 30 and the second lens frame 20 can be maintained. Accordingly, for example, even in a state where the first lens frame 10 is attached to the holding frame 30, the stopper member 47 can be inserted into the insertion port 38 from a lateral side (an outer peripheral side) after the holding frame 30 and the second lens frame 20 are bayonet-engaged with each other. Therefore, the degree of freedom of the procedure for assembly of the lens device 100 is increased.

### Cam Mechanism of Lens Device 100

FIG. 11 is a perspective view showing the cam mechanism 60 of the lens device 100. FIG. 12 is a perspective view showing the fixed cylinder 61 of the cam mechanism 60. FIG. 13 is a perspective view showing the cam cylinder 62 of the cam mechanism 60.

The cam mechanism 60 moves the first lenses 1A and 1B and the second lenses 2A to 2D with respect to a housing of the lens device 100 in a front-rear direction along the optical axis X. The cam mechanism 60 is an example of a "moving mechanism" according to the embodiment of the present invention. The "housing" is a lens barrel of the lens device 100. The lens barrel is fixed to, for example, a lens mount. The expression "to move the first lenses and the second lenses" means to move the first lenses 1A and 1B and the second lenses 2A to 2D while maintaining the relative positions of the first lenses 1A and 1B and the second lenses 2A to 2D (to deliver the lenses as a whole). The movement is, for example, movement for focus adjustment.

As shown in FIG. 11, the cam mechanism 60 includes the fixed cylinder 61, the cam cylinder 62, and the cam followers 22a to 22c. The fixed cylinder 61 has a plate-shaped portion and a tubular portion that extends to the rear side from the plate-shaped portion. Linear movement grooves 63a, 63b, and 63c parallel to the optical axis X are formed at the tubular portion of the fixed cylinder 61 as shown in FIG. 12. The plate-shaped portion of the fixed cylinder 61 is fixed to the housing of the lens device 100. The linear movement grooves 63a, 63b, and 63c are examples of a “groove portion” according to the embodiment of the present invention.

As shown in FIG. 13, cam grooves 64a, 64b, and 64c are formed at the cam cylinder 62. Each of the cam grooves 64a to 64c is formed in a circumferential direction of the cam cylinder 62 to be inclined in one direction. The cam cylinder 62 is attached to an outer side of the tubular portion of the fixed cylinder 61.

The cam followers 22a to 22c are attached to the second lens frame 20 as described with reference to FIG. 5. The cam followers 22a to 22c are engaged with the cam grooves 64a to 64c of the cam cylinder 62 via the linear movement grooves 63a, 63b, and 63c of the fixed cylinder 61.

In FIG. 11, the holding frame 30 and the first lens frame 10 held by the holding frame 30 are mounted into the fixed cylinder 61 from a front side of the fixed cylinder 61. Meanwhile, the second lens frame 20 is mounted into the fixed cylinder 61 from a rear side of the fixed cylinder 61. Then, the groove engagement portions 37a to 37c of the holding frame 30 and the claw engagement portions 21a to 21c of the second lens frame 20 are bayonet-engaged with each other. The cam cylinder 62 is attached to the outer side of the tubular portion of the fixed cylinder 61, to which the first lens frame 10, the holding frame 30, and the second lens frame 20 are mounted, such that the cam cylinder 62 covers the outer side of the tubular portion. The cam followers 22a to 22c are attached to the second lens frame 20, to which the fixed cylinder 61 and the cam cylinder 62 are mounted, via the linear movement grooves 63a, 63b, and 63c of the fixed cylinder 61 and the cam grooves 64a to 64c of the cam cylinder 62.

Because of the cam mechanism 60, in a case where the cam cylinder 62 is rotated around the optical axis X, the second lens frame 20, the holding frame 30 bayonet-engaged with the second lens frame 20, and the first lens frame 10 held by the holding frame 30 move forward and backward along the optical axis X in the fixed cylinder 61 and the cam cylinder 62. Accordingly, the first lenses 1A and 1B and the second lenses 2A to 2D move in the direction along the optical axis X.

As described above, according to the lens device 100, since the holding frame 30 and the second lens frame 20 are bayonet-engaged with each other, the holding frame 30 and the first lens frame 10 can be mounted to the fixed cylinder 61 of the cam mechanism 60 from the front side of the fixed cylinder 61 and the second lens frame 20 can be mounted to the fixed cylinder 61 from the rear side of the fixed cylinder 61. Accordingly, for example, it is possible to suppress an increase in size of the fixed cylinder 61 and to realize size reduction of the lens device 100 even in a case where it is necessary to increase the size of a lens and a case where it is necessary to provide an adjustment mechanism between the first lens frame 10 and the holding frame 30.

### FPC of Stop Unit 50

FIG. 14 is a perspective view showing the way in which an FPC 51 connected to the stop unit 50 is led out. It is desirable that the FPC 51 of the stop unit 50 is led out to the front side (the subject side) in the direction along the optical axis X in a configuration in the lens device 100. In addition, it is desirable that the length of the FPC 51 led out is as short as possible.

Therefore, in a case where the FPC 51 is to be led out to the front side in the direction along the optical axis X and a direction in which the FPC 51 led out is routed is to be changed, an oblique path 52b (a path represented by solid lines) is set as a path through which the FPC 51 is routed, instead of a right-angled path 52a (a path represented by broken lines). Accordingly, it is possible to suppress an increase in length of the FPC 51 and to suppress the size of a space used to route the FPC 51 in the lens device 100.

Note that as described above, the FPC 51 led out from the stop unit 50 is supported by the metal sheet 53 for positional stabilization of wires. The metal sheet 53 is screwed to the rear side of the attachment portion 39 (refer to FIG. 6) of the holding frame 30 by means of the nut 45. In this case, the thickness of the attachment portion 39 in a state where the metal sheet 53 is screwed by means of the nut 45 is smaller than the thickness of the plate-shaped portion of the fixed cylinder 61 (refer to FIG. 11) in which the holding frame 30 moves forward and backward along the optical axis X. Accordingly, it is possible to suppress the size of a space used to provide the attachment portion 39 in the lens device 100 and to increase the degree of freedom in designing the cam mechanism 60.

### Modification Example of First Lens Frame 10 and Holding Frame 30

In the above-described embodiment, the first lens frame 10 and the holding frame 30 are configured as separate bodies and the first lens frame 10 is mounted to the holding frame 30. However, the present invention is not limited thereto. For example, the first lens frame and the holding frame may be configured as one integrated frame (hereinafter, referred to as an integrated frame). In the case of such a configuration, the integrated frame and the second lens frame are bayonet-engaged with each other and a predetermined gap is provided between, for example, a groove engagement portion of the integrated frame and a claw engagement portion of the second lens frame which are bayonet-engaged with each other. To provide the predetermined gap means to provide a wobbling clearance between the engagement portions in a state of being engaged with each other so that it is possible to change the inclination and the position of engagement between the engagement portions. In this way, a gap is provided between the engagement portions, the position and inclination of the integrated frame is adjusted with respect to the direction along the optical axis X after the integrated frame and the second lens frame are bayonet-engaged with each other, and the integrated frame and the second lens frame are fixed to each other by means of, for example, an adhesive in a state where the adjustment is completed.

### EXPLANATION OF REFERENCES

1A, 1B: first lens

2A to 2D: second lens

10: first lens frame

11, 31: opening portion

12, 32: protruding portion

13a to 13c, 14a, 14b: through-hole

15: boss hole

16a to 16e, 36: rib

17a to 17f: notch

20: second lens frame

21a to 21c: claw engagement portion

22a to 22c: cam follower

30: holding frame

33a to 33c: screw hole

35: boss

37a to 37c: groove engagement portion

38: insertion port

39: attachment portion

40: adjustment mechanism

43a to 43c: tilt adjustment screw

44a, 44b: shift adjustment screw

45: nut

46: spring

47: stopper member

50: stop unit

51: FPC

52a, 52b: path

53: metal sheet

60: cam mechanism

61: fixed cylinder

62: cam cylinder

63a, 63b, 63c: linear movement groove

64a to 64c: cam groove

100: lens device

R1, R2: outer diameter

What is claimed is:

1. A lens device comprising:
a first lens frame that holds a first lens;
a holding frame that holds the first lens frame;
an adjustment mechanism with which a positional relationship between the holding frame and the first lens frame is adjustable; and
a second lens frame that holds a second lens,
wherein a first engagement portion of the holding frame and a second engagement portion of the second lens frame are engaged with each other.

2. The lens device according to claim 1,
wherein the adjustment mechanism includes
a first adjustment mechanism with which inclination of the first lens frame with respect to the holding frame is adjustable, and
a second adjustment mechanism with which a position of the first lens frame with respect to the holding frame is adjustable.

3. The lens device according to claim 2,
wherein the holding frame includes a plurality of the first engagement portions, and
the second lens frame includes a plurality of the second engagement portions.

4. The lens device according to claim 3,
wherein the first adjustment mechanism, the second adjustment mechanism, and the first engagement portions are disposed along a circumferential direction around an optical axis of the lens device.

5. The lens device according to claim 4,
wherein the first adjustment mechanism, the second adjustment mechanism, and the first engagement portions are disposed at different positions in the circumferential direction around the optical axis.

6. The lens device according to claim 1,
wherein the first engagement portion and the second engagement portion are engaged with each other in a bayonet manner or a snap-fit manner.

7. The lens device according to claim 6,
wherein the first engagement portion of the holding frame and the second engagement portion of the second lens frame are engaged with each other in the bayonet manner, and
at least one of the first engagement portion of the holding frame or the second engagement portion of the second lens frame has an insertion port into which a stopper member that maintains the engagement in the bayonet manner is insertable in a direction intersecting an optical axis of the lens device.

8. The lens device according to claim 1,
wherein the second lens frame includes a light amount adjustment member, and
the second lens includes a lens of which an outer diameter is larger than an outer diameter of the light amount adjustment member as seen in a direction of an optical axis of the lens device.

9. The lens device according to claim 1, further comprising:
a moving mechanism that moves the first lens and the second lens with respect to a housing.

10. The lens device according to claim 9,
wherein the moving mechanism is a mechanism that moves the first lens and the second lens while maintaining relative positions of the first lens and the second lens.

11. The lens device according to claim 10,
wherein the moving mechanism includes
a fixed cylinder that is fixed to the housing and that includes a groove portion,
a cam cylinder that includes a cam groove, and
a cam follower that is provided at the second lens frame, and
the cam follower is engaged with the cam groove via the groove portion.

12. An imaging apparatus comprising:
the lens device according to claim 1.
